(19) United States
(12) Patent Application Publication
(10) Pub. No.: US 2007/0262173 A1
(43) Pub. Date: Nov. 15, 2007

(54) Spray Nozzle

(76) Inventors: David Robert Percival, Great Sankey (GB); Frank Whittaker, Thelwall (GB); Robert McCarthy, Liverpool (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/747,254

(22) Filed: May 11, 2007

(30) Foreign Application Priority Data
May 12, 2006 (GB) 0609434.6

(51) Int. Cl. F23D 11/16; B05B 7/06

(52) U.S. Cl. 239/420; 239/422; 239/423; 239/424.5; 239/428; 239/583

(57) ABSTRACT

A spray nozzle comprises a cap 38 having an outlet orifice 41 formed therein for producing an atomised spray, the cap 38 having an outer surface 62, and further fluid outlet means 70 whereby a curtain of fluid can be directed over at least part of the outer surface 62.

This invention relates to a spray nozzle for use in the atomisation of fluids. The nozzle may be used in a range of applications, for example in the delivery of dye or colorant particles to products to be coated with the dye.

Spray nozzles for use in the delivery of dye particles typically comprise a valve needle engageable with a seat to control whether or not fluid containing the dye particles is able to flow, under pressure, to an outlet orifice, and an atomisation air flow path along which air is supplied under pressure to the outlet orifice, the air and fluid delivered through the outlet orifice interacting, externally of the nozzle, to atomise the fluid containing the dye particles.

In order to form the mist of atomised fluid so formed into a desired shape, the nozzle may further include horns having flow passages formed therein to which air under pressure is supplied, the air being directed through outlets formed in the horns so as to impinge upon the mist of atomised fluid, flattening the otherwise generally conical spray of mist.

It has been found that, over time, dye particles tend to separate from the spray and collect on the nozzle forming deposits of so-called whiskers or beards, the dye particles tending to adhere to regions of the nozzle where the air flow is static or too low to keep the fine dye particles entrained. Depending upon the size and location of such whiskers, the operation of the nozzle may be affected.

US 2004/0035952 describes a spray nozzle of the general type described above but modified to reduce the risk of the formation of such whiskers. This is achieved by avoiding the provision of sharp transitions between surfaces of the nozzle, instead providing radii of relative large radial curvature at the intersections of surfaces of the nozzle, and by avoiding the use of horns, the inventors of the US 2004/0035952 arrangement having observed that whiskers tend to form where such sharp transitions are provided.

It is an object of the invention to provide a spray nozzle in which the formation of whiskers is reduced.

According to the invention there is provided a spray nozzle comprising a cap having an outlet orifice formed therein for producing an atomised spray, the cap having an outer surface, and further fluid outlet means whereby a curtain of fluid can be directed over at least part of the outer surface.

The curtain of fluid preferably flows in a direction generally parallel to the at least part of the outer surface.

The provision of the fluid outlet means permitting the formation of a curtain of fluid flowing over the outer surface results in particles which may otherwise collect on the cap being washed therefrom. The fluid is conveniently air, but depending upon the application in which the nozzle is used, other gases may be preferred.

The fluid outlet means could comprise opening(s) formed in the cap or in a component located adjacent the cap. Preferably, however, the fluid outlet means is defined by at least one clearance formed between the cap and a housing part located adjacent the cap.

Preferably, the cap is shaped so as to include an outer surface consisting primarily of a first generally planar region and a second generally planar region intersecting with one another at an apex of the cap, the fluid outlet means comprising a first opening arranged to deliver a curtain of fluid over at least part of the first region and a second opening arranged to deliver a curtain of fluid over at least part of the second region.

The outlet orifice is conveniently formed at the apex.

Additional outlet ports may also be provided, conveniently at the apex, to allow fluid to be supplied under pressure to shape the atomised spray formed by the nozzle.

The invention will further be described, by way of example, with reference to the accompanying drawings, in which:

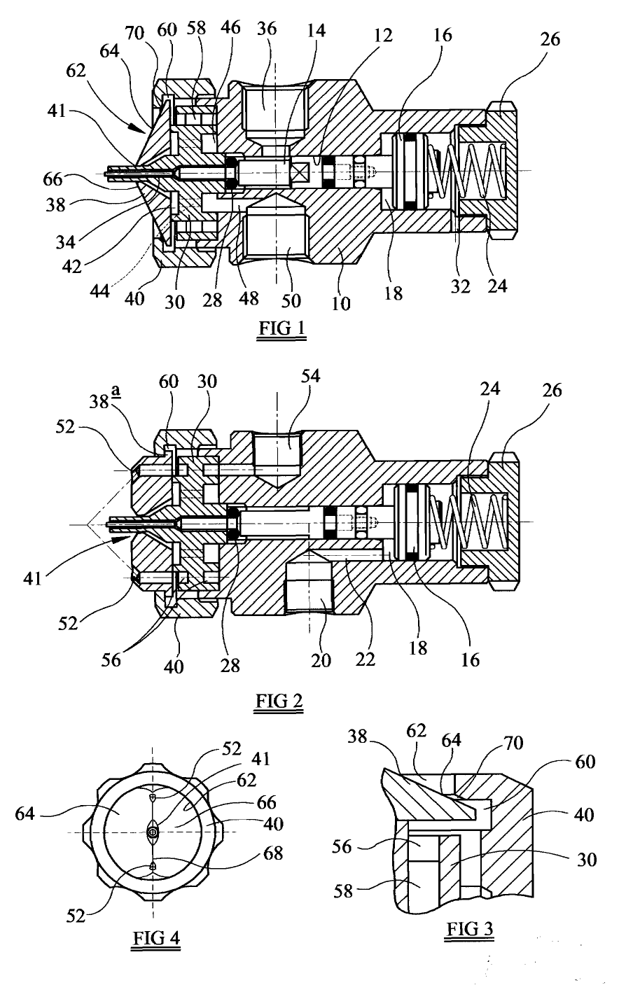

FIGS. 1 and 2 are sectional views illustrating a spray nozzle according to one embodiment of the invention;

FIG. 3 is an enlargement of part of FIG. 1; and

FIG. 4 is an end view of the spray nozzle of FIGS. 1 and 2.

The spray nozzle illustrated in FIGS. 1 to 4 comprises a nozzle body 10 having a throughbore 12 formed therein. A needle 14 is reciprocable within the throughbore 12, the needle 14 including an enlarged diameter piston region 16 slidable within an enlarged diameter region of the bore 12. The enlarged diameter region of the bore 12 and piston region 16 together define a control chamber 18 to which air under pressure can be supplied through a control port 20 and connecting line 22. A spring 24 engages an end surface of the piston region 16, an opposite end of the spring 24 engaging a cap nut 26 which is screw-threaded to the nozzle body 10 to apply a biasing force to the needle 14 urging the needle 14 towards a position in which part thereof engages a seal ring 28 carried by an insert 30. It will be appreciated that, in use, the spring 24 urges the needle 14 into engagement with the seal ring 28, and that upon the application of air under pressure to the control chamber 18, the needle 14 is urged against the action of the spring 24 to lift the needle 14 from the seal ring 28. As illustrated in FIG. 1, a bleed passage 32 is provided to enable air to escape from the chamber containing the spring 24 during such movement. When the supply of air under pressure to the control chamber 18 is terminated, the spring 24 returns the needle 14 into engagement with the seal ring 28.

The insert 30 abuts an end of the nozzle body 10 and includes a through bore 34 which extends coaxially with the throughbore 12. The needle 14 extends through the throughbore 34.

As shown in FIG. 1, the nozzle body 10 includes a dye inlet port 36 which communicates with the throughbore 12, the position occupied by the needle 14 controlling whether or not the dye is able to flow past the seal ring 28 to the throughbore 34.

The insert 30 is held in position by means of a cap 38 which engages a surface of the insert 30 remote from that engaging the nozzle body 10, the cap 38 being secured to the nozzle body by means of a screw-threaded collar 40. The cap 38 defines an outlet orifice 41 through which part of the insert 30 extends, the outlet orifice 41 being aligned with the axis of the throughbore 12. The diameter of the outlet orifice 41 is greater than the outer diameter of the adjacent part of the insert 30 with the result that an annular flow passage is formed therebetween, the annular flow passage communicating with an annular gallery 42 defined by an annular recess formed in the insert 30. The annular gallery 42 communicates with drillings or passages 44 (not in the plane of the sections shown in FIGS. 1 and 2 and so denoted by broken lines) which communicate with a gallery 46 formed by an annular recess provided on the surface of the insert 30 which abuts the nozzle body 10. The gallery 46 communicates through a line 48 with an atomisation air inlet port 50.

As best shown in FIG. 2, the cap 38 further includes a pair of angled outlet ports 52 arranged to be supplied with air under pressure from an air supply connected to a further air inlet 54. As with the arrangement by which the atomisation air supply communicates with the orifice 41, the air supply to the outlet ports 52 is via a pair of galleries 56 formed in the insert 30, the galleries 56 communicating with one another by way of drillings 58. In addition to supplying air to the outlet ports 52, the gallery 56 located on the surface of the insert 30 which abuts the cap 38 further communicates with an annular chamber 60 located between the outer periphery of the cap 38 and the collar 40.

The cap 38 has an outer face 62 made up of a first region 64 and a second region 66 both of which are of generally planar form and which are angled relative to one another, intersecting one another along an apex 68. In the illustrated arrangement, the regions 64, 66 are angled to one another by approximately 128°, but other arrangements are possible. The outlet orifice 41 and the outlet ports 52 are all positioned along the apex 68. As illustrated in FIG. 2, around most of the periphery of the cap 38, the collar 40 abuts an outwardly extending lip 38a to clamp the cap 38 to the nozzle body 10. However, as illustrated in FIGS. 1 and 3 the shape of the cap 38 is such that there are two regions at which a clearance 70 is formed between the cap 38 and collar 40. These regions occur where the shape of the cap 38 is such that the regions 64, 66 extend into or cut through the outwardly extending lip 38a. The clearances 70 communicate with the chamber 60 and are shaped such that the application of air under pressure to the chamber 60 results in air passing through the clearances 70 and flowing over, and in the plane of, the respective regions 64, 66 or at least parts thereof.

In use, air under pressure is supplied to the atomisation air inlet port 50 and the air inlet 54. Fluid containing dye particles is supplied under pressure to the dye inlet port 36. Prior to air being supplied under pressure to the control port 20 and control chamber 18, the spring 24 holds the needle 14 in engagement with the seal ring 28 thus the fluid containing dye particles is prevented from flowing to the throughbore 34. When it is desired to commence spraying of the dye material, air is supplied under pressure to the control port 20 and control chamber 18 urging the needle 14 to the right in the orientation illustrated, lifting the needle 14 from the seal ring 28. The fluid containing the dye particles is thus able to flow along the throughbore 34 to an outlet formed at the end thereof. Air is delivered under pressure to the outlet orifice 41 and interacts with the fluid delivered from the throughbore 34, atomising the fluid and forming it into a mist. The supply of air under pressure to the angled outlet ports 52 serves to shape the mist, flattening the mist from what would otherwise be a generally conical spray pattern to a generally linear form.

The supply of air to the chamber 60 and through the clearances 70 results in air being blown in the form of a planar jet forming an air curtain over the regions 64, 66 forming the outer surface 62 of the cap 38. The flow of air over the outer surface 62 of the cap serves to ensure that the air close to these surfaces is continually moving thus preventing dye particles from being deposited. In addition, the continuous flow of air serves to wash dye particles which may adhere thereto from the cap 38 thus resisting the formation of whiskers or beards of dye particles.

As the outer surface 62 is in the form of two generally planar regions 64, 66 which intersect along a relatively sharp apex 68, it will be appreciated that the curtains of air serving to wash particles from the surface 62 are able to flow over substantially all of the surface 62, few if any regions being formed in which the air flow is low or static.

It will be appreciated that a range of modifications and alterations could be made to the arrangement described hereinbefore. For example, rather than provide outlet means in the form of clearances 70 between the cap 38 and collar 40, a series of outlet openings may be formed in either the cap 38 or the collar 40 to direct air over the outer surface 62 of the cap 38. Additionally or alternatively, a series of outlet openings may be provided in the surfaces 64, 66 communicating through the cap 38 with gallery 56 or chamber 60 to further improve the movement of air in the region of the surfaces 64, 66. Other modifications are also possible.

1. A spray nozzle comprising a cap having an outlet formed therein for producing an atomised spray, the cap having an outer surface, and further fluid outlet means whereby a curtain of fluid can be directed over at least part of the outer surface.

2. A nozzle according to claim 1, wherein the curtain of fluid flows, in use, in a direction substantially parallel to the said at least part of the outer surface.

3. A nozzle according to claim 1, wherein the curtain of fluid comprises pressurised air.

4. A nozzle according to claim 1, wherein the fluid outlet means comprises opening(s) formed in the cap or in a component located adjacent the cap.

5. A nozzle according to claim 1, wherein the fluid outlet means is defined by at least one clearance formed between the cap and a hosing part located adjacent the cap.

6. A nozzle according to claim 1, wherein the cap is shaped so as to include an outer surface consisting primarily of a first generally planar region and a second generally planar region intersecting with one another at an apex of the cap, the fluid outlet means comprising a first opening arranged to deliver a curtain of fluid over at least part of the first region and a second opening arranged to deliver a curtain of fluid over at least part of the second region.

7. A nozzle according to claim 6, wherein the outlet orifice is formed at the apex.

8. A nozzle according to claim 6, further comprising additional outlet ports to allow fluid to be supplied under pressure to shape the atomised spray formed by the nozzle.
